(19) United States
(12) Patent Application Publication
(10) Pub. No.: US 2024/0234899 A1
(43) Pub. Date: Jul. 11, 2024

(54) BATTERY BOX

(71) Applicant: FORD GLOBAL TECHNOLOGIES, LLC, Dearborn, MI (US)

(72) Inventors: Horst Heribert LANZERATH, Bad Muenstereifel (DE); Bjoern HOEREN, Pulheim (DE); Niels PASLIGH, Mönchengladbach (DE); Aleksandar BACH, Aachen (DE); Ilya POPOV, Aachen (DE); Jens BUECHNER, Pulheim (DE)

(73) Assignee: FORD GLOBAL TECHNOLOGIES, LLC, Dearborn, MI (US)

(21) Appl. No.: 18/409,299

(22) Filed: Jan. 10, 2024

(30) Foreign Application Priority Data
Jan. 10, 2023 (DE) 102023100420.4

(51) Int. Cl. H01M 50/242; B60L 50/64; H01M 50/224; H01M 50/271

(52) U.S. Cl. CPC H01M 50/242; B60L 50/64; H01M 50/224; H01M 50/271; H01M 2220/20

(57) ABSTRACT

A battery box for an electric vehicle includes a trough-shaped part made of sheet metal, comprising a bottom floor portion which extends horizontally, lateral wall portions are arranged on both sides in the transverse direction (Y) extending in the upward direction therefrom. An internal sheet metal part is arranged between the wall portions and connected to the trough-shaped part and has floor portions facing the bottom floor portion as well as at least one ridged portion protruding relative to the floor portions and connected in one piece to at least one of the floor portions and extending in the transverse direction (Y), wherein at least one of the floor portions is spaced apart horizontally at least in some regions from the bottom floor portion so that a first intermediate space is formed therebetween.

### CROSS-REFERENCE TO RELATED APPLICATIONS

This application claims foreign priority benefits under 35 U.S.C. § 119(a)-(d) to DE Application 102023100420.4 filed Jan. 10, 2023, which is hereby incorporated by reference in its entirety.

### TECHNICAL FIELD

This application relates to a battery box for an electric vehicle.

Electric vehicles require an energy supply for supplying the drive motor and other systems. In addition to the fuel cells, batteries (for example lithium ion-based batteries) are used, in particular, the batteries normally being arranged as battery modules or battery packs which have a plurality of individual batteries. In order to ensure an adequate charging capacity and thus a sufficient range, a significant volume is currently required for accommodating the batteries. The corresponding installation space is often available on the lower face of the vehicle where the batteries are accommodated in a battery box. This battery box can be dismantled, for example, in order to replace the batteries. The function of the battery box firstly consists in connecting the batteries to the vehicle body, i.e. to function as a mounting element. Secondly, the battery box also protects the batteries from moisture, dirt and mechanical deformation. Depending on the design, it can also be provided that the battery box protects the batteries in an extreme event, in particular due to lateral components. Overall, there are requirements for the lowest possible weight, on the one hand, and the opposing requirement for the highest possible mechanical stability, on the other hand.

### BACKGROUND

DE 10 2016 115 037 A1 discloses a battery box for receiving one or more battery elements for a motor vehicle, having a side wall construction which comprises a box profile which forms an internal region and which at least partially provides outer side walls of the battery box, having a cover, having a base and having an attachment profile for attaching the battery box to the motor vehicle, wherein the side wall construction provides an attachment region which is located further inwardly than the outer side walls for connecting the side wall construction to the cover.

DE 10 2017 117 093 A1 discloses a battery box for receiving a traction battery of a motor vehicle, having a frame which is formed from frame profiles which are connected together via corner connectors. The ends of the frame profile which are held by the at least one corner connector enclose a seal therebetween.

A floor structure for an electrically driven motor vehicle is disclosed in DE 10 2017 205 447 B4, having a battery box which is arranged below a bottom floor, which is attached to supporting structures of the motor vehicle and which is designed as a self-supporting structure, wherein the bottom floor extends horizontally in the motor vehicle in order to form a footwell assigned to the vehicle seats, and wherein the battery box is closed in the direction of the bottom floor by a cover which is oriented toward the bottom floor. The cover has contact elements which are arranged in some regions and which bear directly against the bottom floor in order to bring about a support of the bottom floor by the battery box.

DE 10 2018 110 519 B4 discloses a battery box for arranging below a passenger compartment of an electric vehicle, wherein the battery box has struts which run diagonally to the vehicle longitudinal axis and the vehicle transverse axis in order to stiffen the lower region of the passenger compartment, wherein in each case two struts run from a front frame wall and a rear frame wall of the battery box to a left-hand and right-hand frame wall. Internal bracings which extend in the vehicle longitudinal and/or transverse direction are arranged above a floor of the battery box for defining individual battery modules to be received and for the longitudinal and/or transverse reinforcement of an interior of the battery box. The frame walls, the struts and the internal bracings are thermo-formed and press-hardened or cold-formed from UHSS and/or roll-formed from UHSS.

DE 10 2018 120 268 A1 discloses a battery box for a motor vehicle for receiving battery cells, having a structural frame with at least two structural components joined together on the end, wherein each structural component has at least one profile segment which is configured to be partially hollow and substantially L-shaped in cross section, and a reinforcing element is arranged within at least one of the profile segments for absorbing kinetic energy. The reinforcing element is a shaped part with a plurality of open cells which are arranged adjacent to one another and substantially parallel to one another with their longitudinal extent.

DE 10 2019 123 906 A1 discloses a battery box for receiving at least one battery for an electric vehicle, having an external peripheral frame and having a floor, wherein a peripheral frame reinforcing element is arranged below the frame for reinforcing the frame and wherein the material thickness of the frame reinforcing element corresponds to the cross-sectional height thereof.

### SUMMARY

A battery box which is lightweight and is stable at the same time is provided.

It should be mentioned that the features and measures set forth individually in the following description can be combined together in any technically expedient manner and reveal further embodiments of the disclosure. The description characterizes and specifies one or more embodiments, in particular, additionally in combination with the figures.

A battery box is provided for an electric road vehicle, such as a passenger motor vehicle or truck. The term “electric vehicle” in this case encompasses all vehicles which can be driven at least partially and/or temporarily by an electric motor. This expressly also includes hybrid vehicles which additionally have an internal combustion engine. The battery box serves for receiving a battery unit which stores energy for operating various systems of the electric vehicle, in particular for operating the electric motor. The battery unit can have a plurality of separate battery modules which can be arranged in different regions of the battery box. The battery box in the installed state is connected to a vehicle body (for example a chassis) of the electric vehicle. The battery box can be arranged, for example, on a lower face of the vehicle body. The battery box is provided to protect the battery unit and normally shields against mechanical deformation and against dirt and moisture in the downward direction. The battery box can also shield the battery unit in the horizontal direction and/or in the upward direction.

The battery box has a trough-shaped part made of sheet metal. This trough-shaped part can be formed from aluminum (normally an aluminum alloy) or, in particular, from high-strength steel. In the case of high-strength steel, with for example a martensitic steel having a tensile strength of 1500 MPa, the sheet metal can be configured to be very thin and lightweight, for example with a thickness of at most 1 mm or at most 0.5 mm If steel, sheet steel, or sheet metal is mentioned herein, this always includes the possibility that the steel is coated, for example galvanized. The trough-shaped part is generally configured in one piece, i.e. it is produced by forming from a single piece of sheet metal, in particular sheet steel.

The trough-shaped part comprises a bottom floor portion which extends horizontally, lateral wall portions which are arranged on both sides in the transverse direction extending in the upward direction therefrom. As already mentioned, these portions are generally part of one and the same piece of sheet metal. The bottom floor portion normally closes the battery box in the downward direction. The references to the longitudinal, transverse and vertical direction refer to a coordinate system of the battery box which generally nevertheless coincides with the coordinate system of the electric vehicle (i.e. the longitudinal direction is that of the electric vehicle, etc.) in the installed state as intended. The bottom floor portion extends horizontally, wherein it can run at least partially parallel to the horizontal plane, i.e. the plane which is spanned by the longitudinal direction and the transverse direction. However, the bottom floor portion can also run at least partially at an angle to this plane. In the transverse direction, lateral wall portions are arranged on both sides (so to speak “left” and “right”) of the bottom floor portion. These lateral wall portions normally directly adjoin the bottom floor portion. The lateral wall portions extend in the upward direction, i.e. along the vertical axis or in the vertical direction. The lateral wall portions can run at least partially parallel to the vertical direction. These lateral wall portions extend in the longitudinal direction but they do not have to be oriented parallel to the longitudinal direction or the longitudinal axis, although this is possible. In particular, the wall portions can be angled back once or repeatedly in their upper region. Due to their protruding shape, the wall portions form on both sides of the bottom floor portion boundaries which laterally define at least one receiving space for the battery unit. As a whole, this results in a U-shaped profile in cross section in which the wall portions form the sides of the “U-shape”.

Moreover, the battery box comprises an internal part which is made of sheet metal and which is arranged between the wall portions and connected to the trough-shaped part, and which has floor portions facing the bottom floor portion as well as at least one ridged portion which protrudes relative to the floor portions, which is connected in one piece to at least one floor portion and which extends in the transverse direction. The internal part is also formed from sheet metal and can be formed, as is the trough-shaped part, from aluminum or an aluminum alloy or, in particular, from high-strength steel. Normally, the trough-shaped part and the internal part consist of the same material. The trough-shaped part can be configured in one piece or consist of a plurality of elements. In embodiments in which these elements are not directly connected to one another, they are also denoted in their entirety as the “internal part”. The internal part is connected to the trough-shaped part, for example, by a positive connection, non-positive connection and/or material connection. In particular, these parts can be welded or screwed together. The internal part has floor portions which face the bottom floor portion. The floor portions can run at least partially horizontally. Moreover, the floor portions are normally arranged at least partially adjacent to the bottom floor portion. Preferably, each floor portion is connected to the bottom floor portion, for example, by welding or screwing.

Moreover, the internal part has at least one ridged portion which protrudes relative to the floor portions. In other words, the ridged portion extends higher than the floor portions relative to the vertical axis and thus forms an elevated structure. Accordingly, the respective ridged portion does not extend continuously horizontally but at least in some regions in the upward direction and thus at an angle to the horizontal plane. Moreover, the ridged portion extends in the transverse direction, wherein in particular it can run at least in some portions parallel to the transverse direction. Advantageously, the respective ridged portion extends from one lateral wall portion to the other wall portion and is connected to both wall portions. At least in some embodiments, the ridged portion can also be denoted as a rib portion or as a transverse strut portion. In particular, it is possible to provide a plurality of ridged portions which are spaced apart in the longitudinal direction. Each ridged portion is connected in one piece to at least one floor portion, i.e. these two portions are produced from one and the same sheet metal part.

At least one floor portion is spaced apart horizontally at least in some regions from the bottom floor portion, so that a first intermediate space is configured therebetween. In other words, this results in at least a doubled floor structure in some regions, with a lower wall formed by the bottom floor portion, followed by a first intermediate space and an upper wall formed by the floor portion.

The battery box according to the disclosure can be produced by using sheet metal, in particular high-strength sheet steel, with thin-walled and thus lightweight components. A low overall weight can be achieved thereby, with at the same time a high degree of stability. In this context, the at least one ridged portion is particularly advantageous since it brings about a reinforcement of the battery box relative to any forces acting in the vertical direction or transverse direction. This applies, in particular, when the ridged portion is connected to the lateral wall portions. The reinforcing effect is also substantially better when the ridged portion is connected to the bottom floor portion via a floor portion connected thereto. The doubling of the floor by the bottom floor portion and the at least one floor portion arranged thereabove is also advantageous. This contributes firstly to the further reinforcement of the battery box and to improving the protection of the battery unit on the lower face. Secondly, the first intermediate space which is configured between the bottom floor portion and the floor portion can be used in different ways. At least in some embodiments, it is also advantageous that both the trough-shaped part and the internal part can be produced primarily or exclusively by forming methods, such as bending or roll forming.

For example, the first intermediate space can be filled with a filler material. The first intermediate space can be foamed, for example, with a polymer foam to provide additional protection on the lower face. Moreover, due to the filler material, in particular a foam, a material connection can be produced between the bottom floor portion and the floor portion which contributes further to the reinforcement of the battery box. Alternatively or additionally to a filler material, at least one auxiliary element for the battery unit can be arranged in the first intermediate space, i.e. an element which assists or permits the function of the battery unit. For example, this element could be an electrical cable or, in particular, a cooling element or a coolant line.

One embodiment provides that the internal part has at least one first floor portion bearing against the bottom floor portion as well as at least one second floor portion which is offset in the upward direction relative thereto and which is spaced apart horizontally at least in some regions from the bottom floor portion, so that a first intermediate space is configured therebetween. In other words, this results in a step-like shape in which the first floor portion forms a lower step and the second floor portion forms an upper step. The first floor portion, which is located at a lower position, bears against the bottom floor portion and can be connected thereto, for example, by spot welds. As a whole, the first floor portion can bear flat against the bottom floor portion, which strengthens the connection between these portions and thus the connection of the internal part and trough-shaped part overall. The second floor portion is spaced apart at least in some regions from the bottom floor portion. The first and the second floor portions can advantageously be connected together, in particular in one piece. In other words, they can form portions of one and the same sheet metal part. A second floor portion can be arranged, for example, in the longitudinal direction between a first floor portion and a ridged portion. However, it is also possible that a first floor portion is interposed in the longitudinal direction between a second floor portion and a ridged portion.

According to one embodiment, the bottom floor portion has a base portion as well as connecting structures which protrude in the upward direction relative thereto and which are connected to at least one floor portion, wherein at least one first intermediate space is configured between the base portion and the at least one floor portion. The base portion can extend, for example, parallel to the horizontal plane. The connecting structures can be generated, for example, by forming the sheet metal. The individual connecting structure can be denoted as an embossed portion inside the sheet metal. The connecting structures could be elongated in the manner of a bead or configured locally in the manner of a stud. However, it might also be possible that the connecting structures are at least partially formed by separately produced elements which are retrospectively connected to the sheet metal. For example, a nut or screw could be welded as the connecting structure to the bottom floor portion which then cooperates with a screw or nut, which secures the floor portion to the bottom floor portion. Naturally other embodiments are also conceivable. Generally the respective connecting structures can be connected to the floor portion, in particular by screwing or welding, for example spot welding. The connected floor portion, in particular, can be an above-mentioned second floor portion.

According to an advantageous embodiment, the mechanical stability of the battery box can be further increased if front wall portions, which are arranged on both sides in the longitudinal direction, extend in the upward direction from the bottom floor portion. The front wall portions are arranged on the front face and on the rear face of the bottom floor portion. According to one embodiment, the front wall portions are configured in one piece with the bottom floor portion and with the lateral wall portions. Additionally, for example, they can be connected to the lateral wall portions by direct welding or by connecting corner elements. It is also possible that the front wall portions are formed by separate components or that they are portions of the internal part. The front wall portions can have flange portions on the lower face for attaching to the bottom floor portion and/or lateral flange portions for attaching to the lateral wall portions.

According to one embodiment, the internal part is configured in one piece. The internal part can have a plurality of ridged portions which can be produced by forming, such as for example by bending or roll forming. Additionally a plurality of floor portions, in particular first and second floor portions, can be configured. This embodiment has the advantage that only one component is required for the internal part, which simplifies the assembly of the battery box. On the other hand, the production of the internal part is potentially complex if a larger number of different regions have to be generated in a single sheet metal part. A further embodiment provides that the internal part has a plurality of internal modules, each thereof forming at least one floor portion and at least one part of a ridged portion. The internal modules can be directly connected together. However, it is also possible that two internal modules are simply connected together indirectly via the bottom floor portion. Each internal module has a floor portion, wherein in particular this can be a first floor portion and/or a second floor portion. Although the modular construction involves a greater effort when assembling the battery box, the individual internal modules can be produced with little effort. It is also possible, for example, to design the battery box for receiving different battery units by varying the number or the arrangement of the internal modules.

On the one hand, the internal part can have a plurality of identical internal modules. Various design options are also conceivable, for example the spacing of the internal modules can be varied or the orientation of the individual internal modules can be changed in the case of asymmetrically configured internal modules. Provided this is sufficient for receiving the battery unit and optionally auxiliary elements arranged in the first intermediate space, this embodiment is advantageous since only one type of internal module is required and able to be produced. Alternatively or additionally, the internal part can have a plurality of differently configured internal modules. As a result, further design options are provided regarding the receiving of the battery unit and the optionally provided auxiliary elements. In this context it might be conceivable, for example, that a special type of internal module is provided for the position furthest to the front and furthest to the rear relative to the longitudinal direction, where the internal module forms an aforementioned front wall portion.

One embodiment provides that at least one ridged portion has two flank portions which run in the upward direction and which are spaced apart in the longitudinal direction, as well as a top portion which connects these flank portions and which extends horizontally, wherein a second intermediate space is configured between the ridged portion and the bottom floor portion. The flank portions are arranged relative to the longitudinal direction on the front face and rear face of the ridged portion. Preferably, the flank portions run at an angle of at least 70° to the horizontal plane, in particular they can run vertically at least in some portions. The flank portions are connected at their upper ends by the top portion which extends horizontally and which can run at least in some portions parallel to the horizontal plane. Overall, therefore, the ridged portion can have a U-shaped profile which is open in the downward direction. Due to the spacing of the flank portions, this U-shaped profile defines together with the bottom floor portion a second intermediate space. This second intermediate space can remain empty, whereby the overall weight is minimized. Alternatively, similar to the first intermediate space it can be filled with film material and/or receive an auxiliary element for the battery unit.

In some embodiments, the wall portions can form the outer regions of the battery box. This can be the case, for example, relative to the lateral wall portions when the battery box is arranged between two longitudinal members of the electric vehicle, which due to their stability provide sufficient resistance against extreme events acting from the side. In other cases, it is preferred that a reinforcing element is arranged on at least one wall portion on the outside. Lateral reinforcing elements can be provided on the lateral wall portions. Alternatively or additionally, front reinforcing elements are possible on the front wall portions. The respective reinforcing element can serve primarily to reinforce the battery box relative to forces acting horizontally. Additionally or alternatively, however, in the case of acting forces it can also be provided to absorb energy by deformation. The reinforcing element can be formed from sheet metal, as is the trough-shaped part and the internal part. Advantageously, the reinforcing element is connected to the trough-shaped part, in particular to the adjacent wall portion. The connection can be produced in different ways, for example by welding or screwing. Preferably, the reinforcing element defines at least one hollow space, either alone or together with a different element. For example, the hollow space could be configured between the reinforcing element and the wall element. Naturally, a plurality of hollow spaces is also conceivable. Optionally, such a hollow space could in turn also be foamed in order to increase the energy absorption. The reinforcing element can also be produced by forming sheet metal. The reinforcing element could have a closed profile or an open U-shaped profile, for example. According to one embodiment, the reinforcing element has a meandering or wave-shaped profile.

Optionally, an outer wall extending horizontally can be arranged on at least one reinforcing element on the outside. The outer wall can run at least partially parallel to the vertical direction. The outer wall can be formed from sheet metal, as is the reinforcing element. The outer wall can also potentially be regarded as part of the reinforcing element. Generally the outer wall is connected directly to the reinforcing element. A function of the outer wall can be to divide a locally acting pressure over a larger surface and to transfer it to the reinforcing element. It is also possible that the outer wall is connected directly to a wall portion, for example when the outer wall or the wall portion have a horizontally extending region which bridges the reinforcing element to a certain extent.

According to one embodiment, to a certain extent the respective ridged portion could abut against the lateral wall portion, i.e. a rim on the edge of the sheet metal, which forms the ridged portions, forms a linear bearing region. In order to permit a better connection, for example by spot welding, it is preferred that at least one ridged portion has a flange portion which is connected to a wall portion in the transverse direction on the end face. The flange portion is formed by an angled-ridged portion of the sheet metal part. While the ridged portion extends in its entirety in the transverse direction, the flange portion runs in the longitudinal direction parallel to the lateral wall portion. The flange portion can adjoin, in particular, an above-mentioned flank portion of the ridged portion.

According to one embodiment, the battery box has a frame element on the edge on a lower face. The frame element is normally configured over the entire periphery. The frame element can be arranged vertically below the reinforcing element. The frame element can produce a connection on the lower face between an outer wall and the trough-shaped part. In addition to a mechanical reinforcement, the frame element can also serve to prevent the ingress of dirt and moisture, for example in the region between the outer wall and trough-shaped part. It can also serve for attaching the battery box to the vehicle body. For example, the frame element can have through-openings for screws, by which the battery frame is screwed to the vehicle body.

A further embodiment provides that the battery box has a cover element which is connected on the upper face to the wall portions. This cover element can be formed from sheet metal or plastics. Normally, the cover element extends substantially horizontally. The cover element forms a closure of the battery box on the upper face and protects the battery unit, which is located on the inside thereof, primarily from dirt and moisture. To a certain degree, the cover element can also increase the mechanical stability of the battery box. On the edge, the cover element can be connected to the wall portions, a reinforcing element and/or an outer wall, wherein the connection can be configured in a releasable manner in order to permit non-destructive access to the battery unit. For example, the cover element can be screwed on.

Further advantageous details and effects of the disclosure are described in more detail hereinafter with reference to various exemplary embodiments shown in the figures. In the figures

### BRIEF DESCRIPTION OF THE DRAWINGS

FIG. 1 shows an exploded view of a first embodiment of a battery box according to the disclosure;

FIG. 2 shows a perspective view of parts of the battery box of FIG. 1 of a battery unit and a first embodiment of a large vehicle with loaded containers of the battery box of FIG. 1,

FIG. 3 shows a sectional view of a detail of the battery box of FIG. 1;

FIG. 4 shows a sectional view of a detail of a second embodiment of a battery box according to the disclosure;

FIG. 5 shows a perspective view of an internal part of the battery box of FIG. 1;

FIG. 6 shows a perspective view of an internal part of a third embodiment of a battery box according to the disclosure;

FIG. 7 shows a perspective view of parts of a fourth embodiment of a battery box according to the disclosure;

FIG. 8 shows a sectional view of a part of the battery box of FIG. 1;

FIG. 9 shows a sectional view of a fifth embodiment of a battery box according to the disclosure;

FIG. 10 shows a sectional view of a sixth embodiment of a battery box according to the disclosure;

FIG. 11 shows a detailed view of FIG. 9;

FIG. 12 shows a detailed view corresponding to FIG. 10 of a seventh embodiment of a battery box according to the disclosure;

FIGS. 13-14 show perspective detailed views of an eighth and ninth embodiment of a battery box according to the disclosure;

FIG. 15 shows a side view of internal modules of a tenth embodiment of a battery box according to the disclosure; and

FIG. 16 shows an internal module of FIG. 15 combined to form an internal part.

### DETAILED DESCRIPTION

As required, detailed embodiments of the present disclosure are described herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the embodiments.

The same parts are always provided with the same reference signs in the various figures, which is why they are generally only described once.

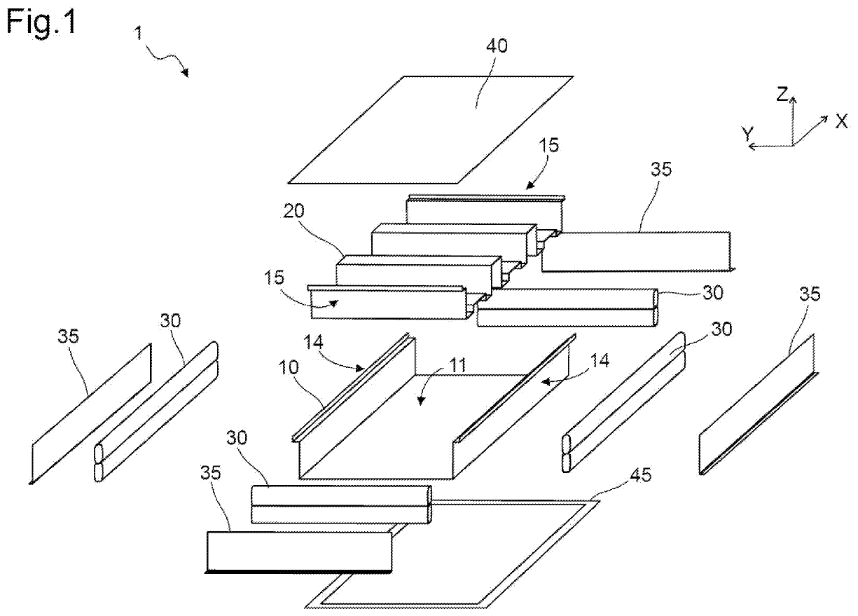

FIG. 1 shows an exploded view of a battery box 1 according to the disclosure which is provided for installation in an electric vehicle, not shown, for example a passenger motor vehicle. The longitudinal direction X, the transverse direction Y and the vertical direction Z of the battery box 1, which in the installed state correspond to the aforementioned directions or axes of the electric vehicle, are illustrated herein and in the further figures. A U-shaped trough part 10 which is produced from a single piece of high-strength sheet steel can be identified. The profile of the U/trough-shaped part 10 can be produced, for example, by roll forming. The trough-shaped part 10 has a substantially horizontally running bottom floor portion 11 and, in the transverse direction Y on both sides thereof, two lateral wall portions 14 which run substantially parallel to the longitudinal direction X and to the vertical direction Z but are bent back twice in the upper region.

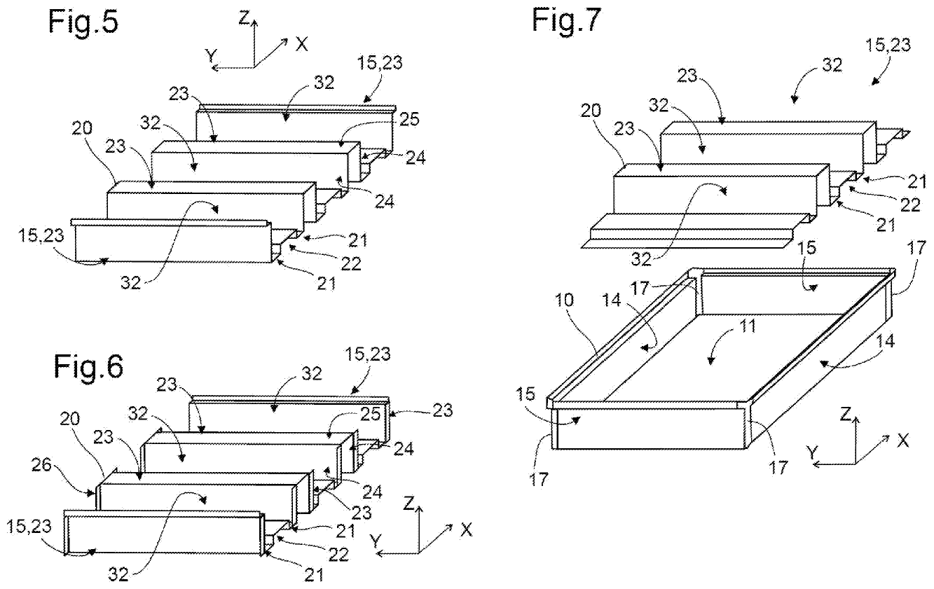

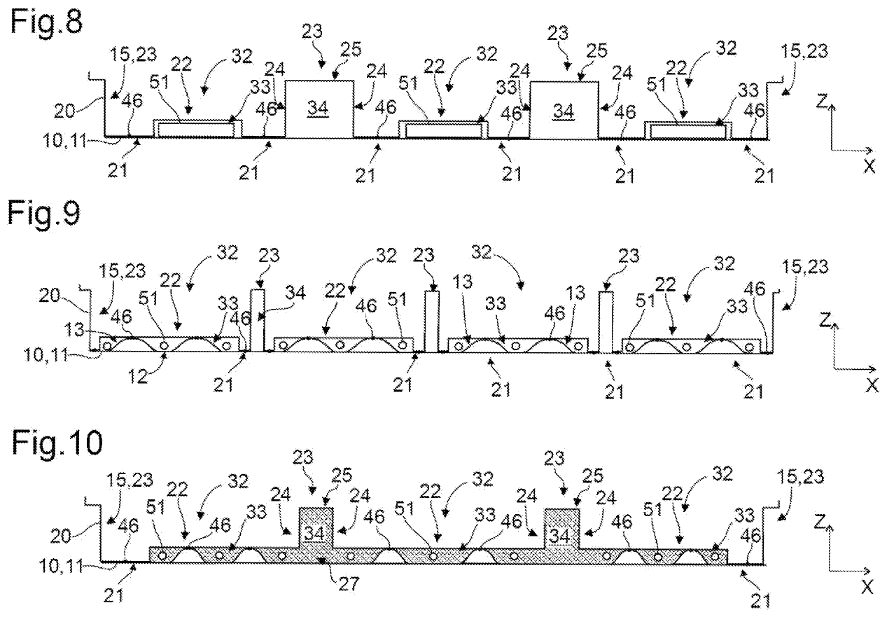

An internal part 20 which is also produced from a single unitary piece of high-strength sheet steel can also be identified. In this case the profile can also be produced by roll forming. The internal part 20, which is shown separately in FIG. 5, has a plurality of floor portions 21, 22, which in the installed state face the bottom floor portion 11, and a plurality of ridged portions 23, which protrude upwardly relative to the floor portions 21, 22 relative to the vertical direction Z. In this case, a total of six first floor portions 21 which in the installed state bear against the bottom floor portion 11 are provided, as can be identified for example in the sectional view in FIG. 8, and three second floor portions 22 which are spaced apart vertically from the bottom floor portion 11 and define first intermediate spaces 33. Two ridged portions 23 have in each case perpendicularly running flank portions 24 and a top portion 25 which is arranged on the upper face and which extends horizontally. Relative to the X-axis, further ridged portions 23, which in this example form front/rear wall portions 15, are configured in each case on the end. The front/rear wall portions 15 have a similar profile to the lateral wall portions 14 but run parallel to the transverse direction Y.

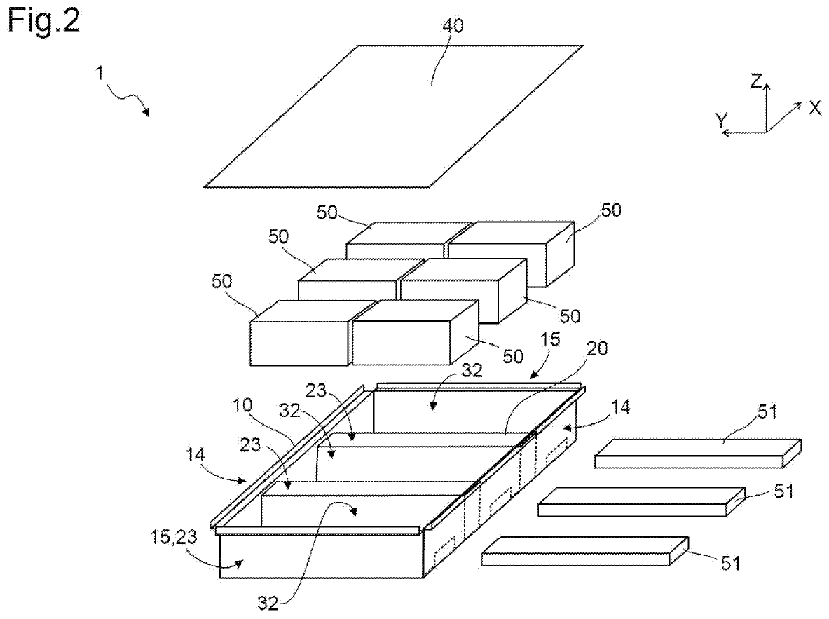

The internal part 20 is dimensioned such that it can be inserted between the lateral wall portions 14, after which the first floor portions 21 can be connected by spot welds to the bottom floor portion 11. Moreover, the flank portions 24 of the ridged portions 23 which abut against the lateral wall portions 14 can be welded to the wall portions 14. The corresponding assembly of the internal part 20 and the trough-shaped part 10 is revealed in FIG. 2 and FIG. 8. According to a second embodiment shown in FIG. 6, relative to the Y-axis, flange portions 26, which can be produced by bending the sheet metal, can be arranged on the end face on the ridged portions 23. In the installed state, the flange portions 26 bear against the lateral wall portions 14 and can be connected thereto by spot welds 46.

As is revealed in FIG. 2, for example, the trough-shaped part 10 and the internal part 20 define receiving regions 32 which are arranged in each case between two ridged portions 23 for battery modules 50 of a battery unit. Moreover, cooling elements 51 which are shown highly schematically in FIGS. 2 and 8 can be received in the first intermediate spaces 33. Two intermediate spaces 34, which remain empty in this example, are configured between the ridged portions 23 and the bottom floor portion 11.

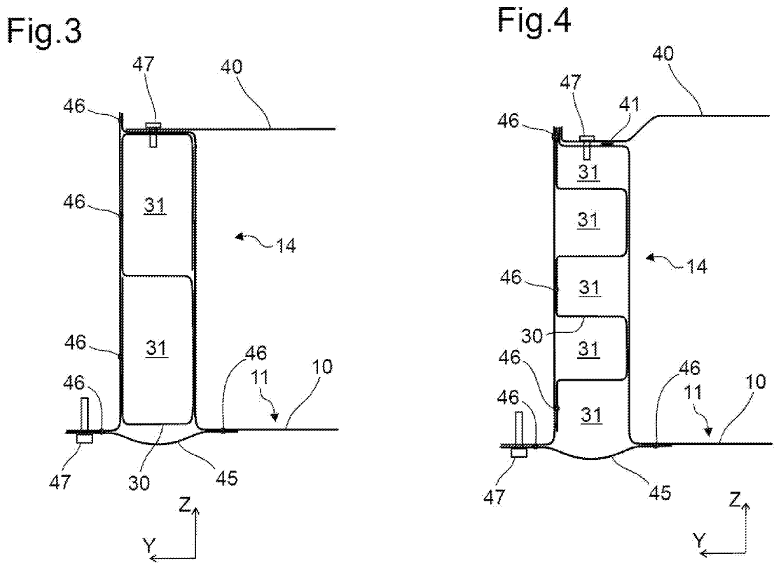

The battery box 1 also has reinforcing elements 30 which are arranged in the horizontal direction on the outside of each wall portion 14, 15, as can be identified in particular from the sectional view of FIG. 3. The reinforcing elements 30 may form a stacked open tubular structure produced from a single piece of high-strength sheet steel and have a cross section which is similar to a “figure eight” and defines two hollow spaces 31. In this manner, the respective reinforcing element 30 reinforces the respective wall portions 14, 15 outwardly but can also absorb deformation energy, wherein the hollow spaces 31 can be at least partially pushed together. In turn, outer walls 35 which are also produced from sheet steel are arranged outwardly on the outside of the reinforcing elements 30. As revealed in FIG. 3, the outer walls in each case are connected to the wall portions 14, 15 and to the reinforcing elements 30 by spot welds 46. On the lower face, the battery box 1 has a peripheral frame element 45 which is connected by spot welds 46 to the bottom floor portion 11 and to the outer wall 35. Screws 47 can be guided through holes, not shown in FIG. 1, in the frame element 45 and in a horizontal flange portion of the outer wall 35 and connected to the vehicle body of the electric vehicle, for example to a longitudinal member or a further part of the chassis.

The battery box 1 is closed upwardly by a top cover element 40 which can also be formed from sheet steel or from plastics. This top cover element 40 is configured in this example in a planar manner and runs in the horizontal direction. The top element is also connected by screws 47 to the trough-shaped part 10, wherein the screws 47 according to FIG. 3 are guided through the upper part of the wall portion 14, 15 and through the reinforcing element 30.

FIG. 4 shows a modified embodiment of a reinforcing element 30 which has a meandering corrugated shape of alternating ridges and grooves that define a total of five hollow spaces 31 between itself and the outer wall 35 or between itself and the wall portion 14, 15 and the frame element 45. Moreover, in this example the top element 40 is bulged in the upward direction in order to enlarge the receiving region 32 for the battery modules 50, without extending the wall portions 14, 15 vertically. An elastomer sealing element 41 is interposed between the top element 40 and the upper part of the wall portion 14, 15.

FIG. 7 shows a trough-shaped part 10 and an internal part 20 of a further embodiment of a battery box 1 which as a whole is substantially configured as the first embodiment, shown respectively in FIGS. 1, 2, 3, 5 and 8. However, in this case the front wall portions 15 are not formed by the internal part 20, but by the trough-shaped part 10. In each case a front wall portion 15 and a lateral wall portion 14 are connected by a corner element 17 which can be configured from plastics or metal.

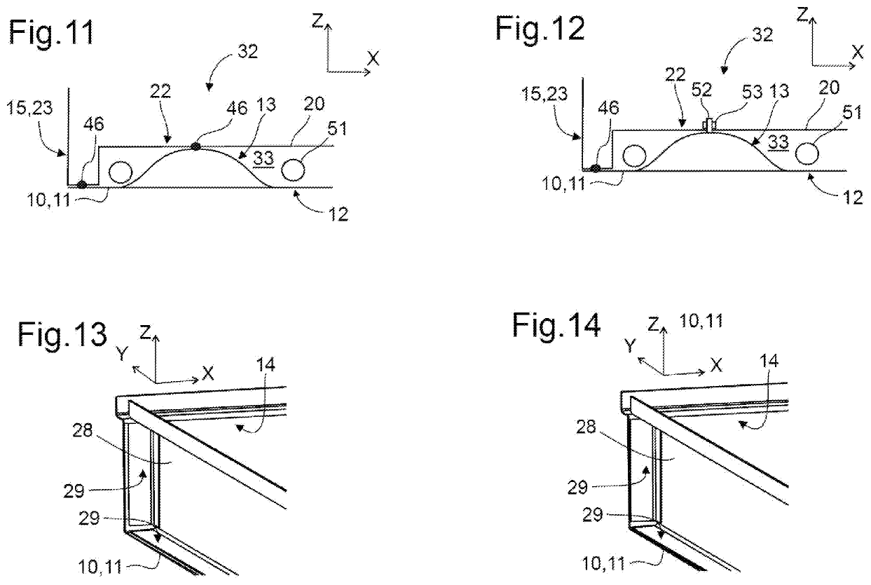

FIG. 9 shows a further embodiment of a battery box 1, wherein only the trough-shaped part 10 and the internal part 20 are shown. In this case, a total of four receiving regions 32 are provided for battery modules 50 which are separated from one another by three ridged portions 23. Two first floor portions 21 which are connected in turn by spot welds 46 to the bottom floor portion 11 and a second floor portion 22 are configured in each case below each receiving region 32. This second floor portion is also connected by spot welds 46 to the bottom floor portion 11. In order to permit this, the bottom floor portion 11 has, in addition to a planar base portion 12, upwardly protruding embossed portions which form connecting structures 13. Each connecting structure 13 is connected by a spot weld 46 to the second floor portion 22, as can also be identified in FIG. 11. Alternatively to a welded connection, corresponding to FIG. 12, a threaded bolt 52 which is guided through an opening in the second floor portion 22 and secured by a nut 53 could also be welded to the connecting structure 13. In turn, cooling elements 51 can be arranged between the connecting structures 13.

FIG. 10 shows a further embodiment of a battery box, in which once again three receiving regions 32 are provided for battery modules 50 which are separated from one another by two ridged portions 23. A second floor portion 22 is configured between these ridged portions 23, while a second floor portion 22 and a first floor portion 21, which once again are connected by spot welds 46 to the base portion 12 or to the connecting structures 13, are configured in each case on the end. In this case, the first intermediate spaces 33 and the second intermediate spaces 34 are filled with filler material 27, for example with a polymer foam.

FIGS. 13 and 14 show details of embodiments in which the front wall portion 15 is formed by a separate wall plate 28, which is connected via flange portions 29 to the bottom floor portion 11 and the lateral wall portion 14. In the embodiment according to FIG. 13, the flange portions 29 do not protrude to the end of the trough-shaped part in the longitudinal direction X. This facilitates the attachment of sealing material, in order to protect this region from the ingress of moisture and from corrosion.

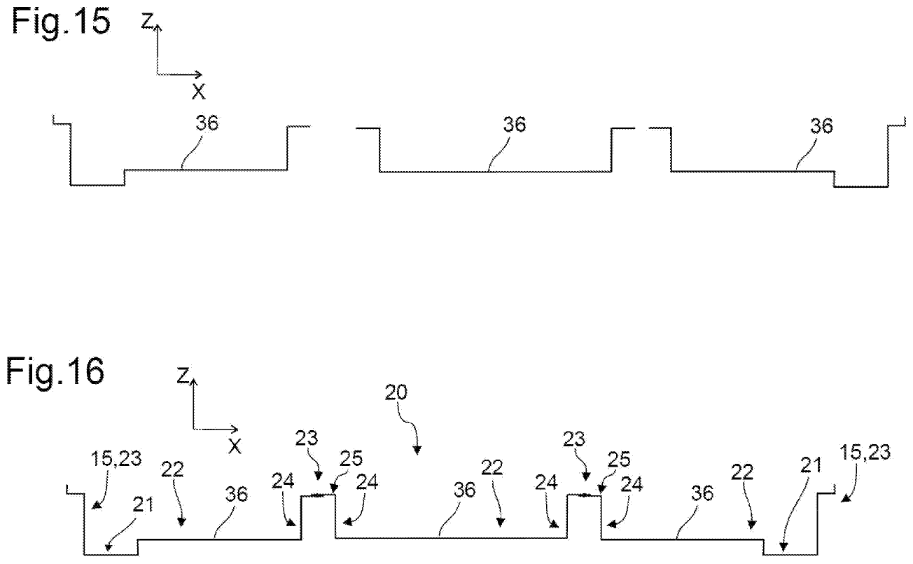

FIGS. 15 and 16 show an embodiment in which the internal part 20 is not produced from a single sheet metal part, but from a plurality of internal modules 36. The resulting shape of the internal part 20 corresponds to the embodiment in FIG. 10. In this case three internal modules 36, which are shown separately in FIG. 15, are provided. Two internal modules 36 on the end which form the first floor portions 21 and the second floor portions 22 on the outside are configured mirror-symmetrically, i.e. they have an identical shape and are merely opposingly oriented. A central internal module 36, which forms the central second floor portion 22, differs in terms of its shape. Each of the internal modules 36 forms in each case a part of one of the ridged portions 23. In the assembled state, the internal modules 36 partially overlap and are connected by spot welds 46.

While exemplary embodiments are described above, it is not intended that these embodiments describe all possible forms of the claimed subject matter. The words used in the specification are words of description rather than limitation, and it is understood that various changes may be made without departing from the claimed subject matter. Additionally, the features of various implementing embodiments may be combined to form further embodiments of the claimed subject matter that may not be explicitly described or illustrated.

What is claimed is:

1. An electric vehicle battery box, comprising:
a trough-shaped sheet steel part having a bottom floor portion extending horizontally in a longitudinal direction (X), lateral wall portions arranged on two sides of the bottom floor portion in a transverse direction (Y) extending in an upward direction from the bottom floor portion, and an internal sheet steel part arranged between the lateral wall portions and connected to the trough-shaped sheet steel part, the internal sheet steel part having floor portions facing the bottom floor portion and at least one ridged portion protruding relative to the floor portions and connected in one piece to at least one of the floor portions, the at least one ridged portion extending in the transverse direction (Y), wherein at least one of the floor portions is spaced apart horizontally in at least some regions from the bottom floor portion to define at least one first intermediate space therebetween.

2. The electric vehicle battery box of claim 1, wherein the internal sheet steel part has at least one first floor portion bearing against the bottom floor portion and at least one second floor portion offset in an upward direction relative thereto and spaced apart horizontally at least in some regions from the bottom floor portion to define the at least one first intermediate space therebetween.

3. The electric vehicle battery box of claim 2, wherein the bottom floor portion has a base portion as well as connecting structures which protrude in the upward direction relative thereto and which are connected to at least one of the floor portions, wherein the at least one first intermediate space is configured between the base portion and the at least one of the floor portions.

4. The electric vehicle battery box of claim 3, wherein front wall portions are arranged on both sides in the transverse direction (Y) and extend in the upward direction from the bottom floor portion.

5. The electric vehicle battery box of claim 4, wherein the internal part is configured in one piece.

6. The electric vehicle battery box of claim 4, wherein the internal part has a plurality of internal modules each forming at least one of the floor portions, and at least one part of a ridged portion.

7. The electric vehicle battery box of claim 4, wherein the internal part has a plurality of identical internal modules.

8. The electric vehicle battery box of claim 4, wherein the at least one ridged portion has two flank portions extending in an upward direction (Z) and spaced apart in the transverse direction (Y), as well as a top portion which connects the two flank portions and which extends horizontally in the transverse direction (Y), and wherein at least one second intermediate space is formed between the at least one ridged portion and the bottom floor portion.

9. The electric vehicle battery box of claim 4, wherein a reinforcing element is arranged on an outside of at least one of the lateral wall portions.

10. The electric vehicle battery box of claim 4, wherein the at least one ridged portion has flange portions connected to the lateral wall portions in the transverse direction (Y) on an end face.

11. The electric vehicle battery box of claim 4, further comprising a frame element on an outer edge of a lower face of the bottom floor portion.

12. The electric vehicle battery box of claim 11, further comprising a cover element connected to the wall portions on an upper face thereof.

13. The electric vehicle battery box of claim 4, wherein the internal part comprises a single unitary piece of sheet steel.

14. An electric vehicle battery box, comprising:
a U-shaped trough formed by a single unitary piece of sheet steel having a bottom floor portion and opposing lateral wall portions extending upward from the bottom floor portion;
an internal part formed by a single unitary piece of sheet steel having a plurality of first floor portions and second floor portions, each of the second floor portions extending upward from two adjacent first floor portions, the internal part further including a plurality of ridged portions each extending upward from associated first floor portions and positioned between the second floor portions, the first and second floor portions and the ridged portions arranged between the lateral wall portions and connected to the U-shaped trough, each ridged portion having two flank portions extending upward from the associated first floor portions and a top portion connecting the two flank portions;
a front wall portion connected to the bottom floor portion and a front edge of the opposing lateral wall portions;
a rear wall portion connected to the bottom floor portion and a rear edge of the opposing lateral wall portions; and
a cover connected to a top edge of the front, rear, and lateral wall portions.

15. The electric vehicle battery box of claim 14 further comprising a plurality of sheet steel reinforcing elements each extending along one of the front, rear, and lateral wall portions.

16. The electric vehicle battery box of claim 15 wherein each of the sheet steel reinforcing elements comprises a single unitary piece of sheet steel.

17. The electric vehicle battery box of claim 16 wherein each of the sheet steel reinforcing elements has a figure-eight-shaped cross section.

18. The electric vehicle battery box of claim 16 wherein each of the sheet steel reinforcing elements comprises a corrugated reinforcing element.

19. An electric vehicle battery box, comprising:
a sheet steel trough having a bottom floor portion and opposing lateral wall portions extending upward from the bottom floor portion;
an internal sheet steel part having a plurality of first floor portions contacting the bottom floor portion and second floor portions raised from the bottom floor portion, each of the second floor portions extending upward from two adjacent first floor portions, the internal part further including a plurality of ridged portions each extending upward from associated first floor portions and positioned between the second floor portions, the first and second floor portions and the ridged portions arranged between the lateral wall portions, each ridged portion having two flank portions extending upward from the associated first floor portions, and a top portion connecting the two flank portions;
a front wall portion connected to the bottom floor portion and a front edge of the opposing lateral wall portions; and
a rear wall portion connected to the bottom floor portion and a rear edge of the opposing lateral wall portions;
wherein the internal sheet steel part is secured only to the front and rear wall portions.

20. The electric vehicle battery box of claim 19 further comprising a plurality of sheet steel reinforcing elements each comprising a single unitary piece of sheet steel and having one of a corrugated cross section and a figure-eight-shaped cross section.
